(19) United States
(12) Patent Application Publication
(10) Pub. No.: US 2020/0327450 A1
(43) Pub. Date: Oct. 15, 2020

(54) ADDRESSING A LOSS-METRIC MISMATCH WITH ADAPTIVE LOSS ALIGNMENT

(71) Applicant: Apple Inc., Cupertino, CA (US)

(72) Inventors: Chen HUANG, Cupertino, CA (US); Joshua M. SUSSKIND, Campbell, CA (US); Carlos GUESTRIN, Seattle, WA (US)

(21) Appl. No.: 16/384,738

(22) Filed: Apr. 15, 2019

(51) Int. Cl. G06N 20/00

(52) U.S. Cl. CPC G06N 20/00

(57) ABSTRACT

The subject technology trains, for a first set of iterations, a first machine learning model using a loss function with a first set of parameters. The subject technology determines, by a second machine learning model, a state of the first machine learning model corresponding to the first set of iterations. The subject technology determines, by the second machine learning model, an action for updating the loss function based on the state of the first machine learning model. The subject technology updates, by the second machine learning model, the loss function based at least in part on the action, where the updated loss function includes a second set of parameters corresponding to a change in values of the first set of parameters. The subject technology trains, for a second set of iterations, the first machine learning model using the updated loss function with the second set of parameters.

### TECHNICAL FIELD

The present description generally relates to developing machine learning applications.

### BACKGROUND

Software engineers and scientists have been using computer hardware for machine learning to make improvements across different industry applications including image classification, video analytics, speech recognition and natural language processing, etc.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example network environment for in accordance with one or more implementations.

FIG. 2 illustrates an example computing architecture for a system providing an adaptive loss function for machine learning models, in accordance with one or more implementations.

FIG. 3 conceptually illustrates an example configuration for an adaptive loss alignment (ALA) controller that runs on a given electronic device in accordance with one or more implementations.

FIG. 4 conceptually illustrates example statements for an algorithm that implements reinforcement learning (RL) for adaptive loss alignment in accordance with one or more implementations.

FIG. 5 conceptually illustrates example charts with an analysis of optimization vs. generalization in accordance with one or more implementations.

FIG. 6 conceptually illustrates an example chart with an analysis loss surface non-convexity in accordance with one or more implementations.

FIG. 7 conceptually illustrates example charts with an analysis of loss-metric mismatch, and validation loss vs. test metric of classification error, and area under the precision-recall curve in accordance with one or more implementations.

FIG. 8 conceptually illustrates example charts illustrating sample efficiency of a RL approach for ALA in accordance with one or more implementations.

FIG. 9 conceptually illustrates an example chart illustrating an evolution of class correlation scores on a given image data set in accordance with one or more implementations.

FIG. 10 conceptually illustrates example charts illustrating a positive distance function and a negative distance function in metric learning in accordance with one or more implementations.

FIG. 11 illustrates a flow diagram of an example process for providing an adaptive loss alignment for training a machine learning model in accordance with one or more implementations.

FIG. 12 illustrates an electronic system with which one or more implementations of the subject technology may be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In one or more implementations, structures and components are shown in block diagram form in order to avoid obscuring the concepts of the subject technology.

Machine learning has seen a significant rise in popularity in recent years due to the availability of massive amounts of training data, and advances in more powerful and efficient computing hardware. Machine learning may utilize models that are executed to provide predictions in particular applications (e.g., analyzing images and videos, fraud detection, etc.) among many other types of applications.

The subject technology provides techniques for an adaptive loss function that works within the context of metric learning and classification. Specifically, a technique called adaptive loss alignment (ALA) is provided which automatically adjusts loss function parameters to directly optimize an evaluation metric on a validation set. Further, this technique also can result in a reduction of a generalization gap, which refers to a difference between a training error and a generalization error which may occur when capacity is increased and training error decreases, but the gap between training error and generalization error increases. A machine learning model's “capacity” refers to its ability to fit a wide variety of functions. Models with low capacity may struggle to fit a training set of data. Models with high capacity can overfit data by memorizing properties of the training set that do not serve them well on the test set.

In an example, a loss function provides a measure of a difference between a predicted value and an actual value, which can be implemented using a set of parameters where the type of parameters that are utilized can impact different error measurements. One challenge in machine learning is that a given machine learning model algorithm should, in order to provide a good model, perform well on new, previously unseen inputs, and not solely on those inputs which the model was trained. The ability to perform well on previously unobserved inputs is called generalization. When training a machine learning model, an error measure on a given training set of data can be determined, called the training error, with a goal of reducing this training error during training. However, in developing the machine learning algorithm, it is also a goal to lower the generalization error, also called the test error. In an example, the generalization error is defined as the expected value of the error on a new input where the expectation can be taken across different possible inputs that are taken from the distribution of inputs that the system is expected to encounter in practice. As described further herein, the ALA technique provides an adaptive loss function that can update parameters of the loss function in order to advantageously improve the aforementioned error measurements.

Machine learning models, including deep neural networks, are difficult to optimize, particularly for real world performance. One reason is that default loss functions are not always good approximations to evaluation metrics, a phenomenon called a loss-metric mismatch. In at least an implementation, the ALA technique learns to adjust the loss function using reinforcement learning (RL) at the same time as the model weights are being learned using a gradient descent technique. A gradient descent technique can refer to a technique for minimizing a function based at least in part on a derivative of the function, which can be used during training of a given machine learning model (e.g., neural network). This approach helps align the loss function to the evaluation metric cumulatively over successive training iterations. ALA as described herein differs from other techniques by optimizing the evaluation metric directly via a sample efficient RL policy that iteratively adjusts the loss function.

Implementations of the subject technology improve the computing functionality of a given electronic device by providing a sample efficient RL approach to address the loss-metric mismatch directly by continuously adapting the loss thereby reducing processing requirements for a machine learning model. Prior approaches waited until training the model was completed in order to update the loss function. The subject technology therefore avoids this by advantageously continuously adapting the loss function. These benefits therefore are understood as improving the computing functionality of a given electronic device, such as an end user device which may generally have less computational and/or power resources available than, e.g., one or more cloud-based servers.

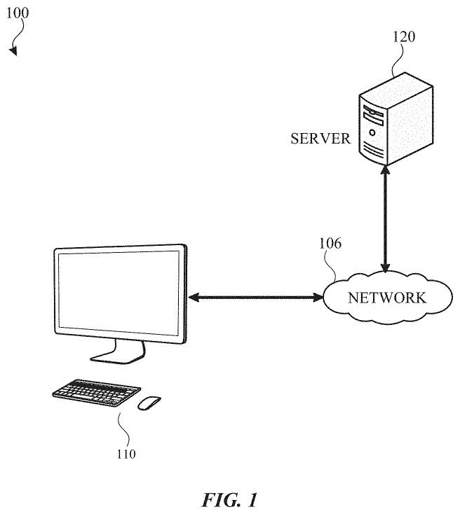

FIG. 1 illustrates an example network environment 100 for in accordance with one or more implementations. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes an electronic device 110, and a server 120. The network 106 may communicatively (directly or indirectly) couple the electronic device 110 and/or the server 120. In one or more implementations, the network 106 may be an interconnected network of devices that may include, or may be communicatively coupled to, the Internet. For explanatory purposes, the network environment 100 is illustrated in FIG. 1 as including the electronic device 110, and the server 120; however, the network environment 100 may include any number of electronic devices and any number of servers.

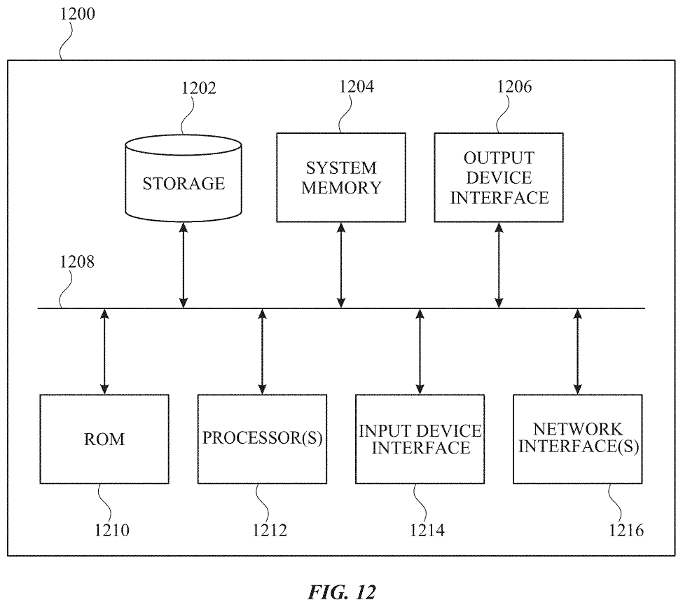

The electronic device 110 may be, for example, desktop computer, a portable computing device such as a laptop computer, a smartphone, a peripheral device (e.g., a digital camera, headphones), a tablet device, a wearable device such as a watch, a band, and the like. In FIG. 1, by way of example, the electronic device 110 is depicted as a mobile electronic device (e.g., smartphone). The electronic device 110 may be, and/or may include all or part of, the electronic system discussed below with respect to FIG. 12.

In one or more implementations, the electronic device 110 may provide a system for training a machine learning model using training data, where the trained machine learning model is subsequently deployed to the electronic device 110. Further, the electronic device 110 may provide one or more machine learning frameworks for training machine learning models and/or developing applications using such machine learning models. In an example, such machine learning frameworks can provide various machine learning algorithms and models for different problem domains in machine learning. In an example, the electronic device 110 may include a deployed machine learning model that provides an output of data corresponding to a prediction or some other type of machine learning output.

The server 120 may provide a system for training a machine learning model using training data, where the trained machine learning model is subsequently deployed to the server 120. In an implementation, the server 120 may train a given machine learning model for deployment to a client electronic device (e.g., the electronic device 110). The machine learning model deployed on the server 120 can then perform one or more machine learning algorithms. In an implementation, the server 120 provides a cloud service that utilizes the trained machine learning model and continually learns over time.

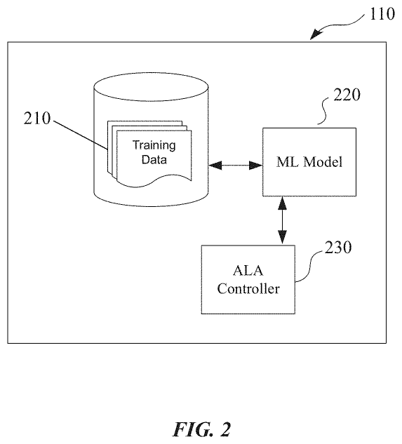

FIG. 2 illustrates an example computing architecture for a system providing an adaptive loss function for machine learning models, in accordance with one or more implementations. For explanatory purposes, the computing architecture is described as being provided by the electronic device 110, such as by a processor and/or memory of the electronic device 110; however, the computing architecture may be implemented by any other electronic devices, such as the server 120. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

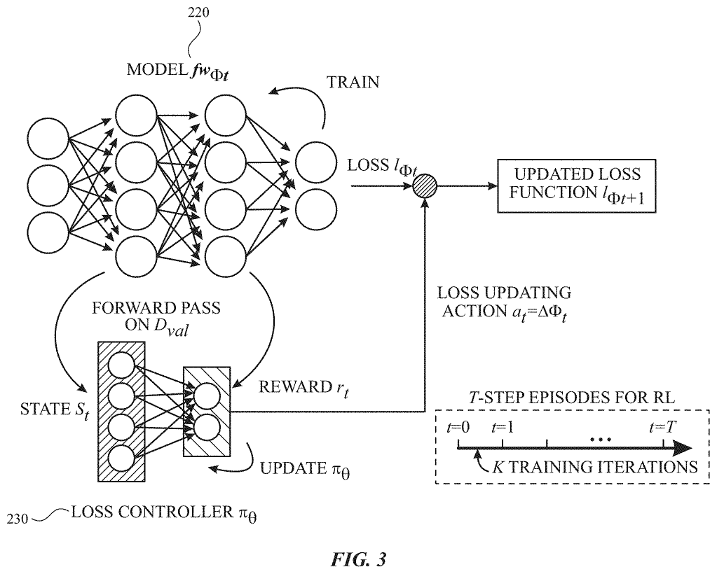

As illustrated, the electronic device 110 includes training data 210 for training a machine learning model. In an example, the electronic device 110 may utilize one or more machine learning algorithms that uses training data 210 for training a machine learning (ML) model 220. The electronic device 110 further includes an adaptive loss alignment (ALA) controller 230 which performs operations for providing an adaptive loss alignment function which automatically adjusts loss function parameters to directly optimize an evaluation metric on a validation set, which is discussed in more detail below in FIG. 3. The ALA controller 230 is also described in more detail in FIG. 3 below. In an example, the ALA controller 230 is implemented as a neural network or another type of model as described further below.

FIG. 3 conceptually illustrates an example configuration for an adaptive loss alignment (ALA) controller that runs on a given electronic device (e.g., the electronic device 110) in accordance with one or more implementations. FIG. 3 will be discussed by reference to FIG. 2, particularly with respect to respective components of the electronic device 110.

In an implementation, a machine learning problem addressed by the ML model 220 can be defined as improving an evaluation metric M(f_{w}, Dᵥₐₗ) on a validation set Dᵥₐₗ, for a parametric model f_{w}: X→Y. In an example, a parametric model learns a function described by a parameter vector that has a finite size that is fixed before any data is observed. The evaluation metric M between the ground-truth y and model prediction f_{w} (x) given an input x, can be either decomposable over samples (e.g., classification error) or non-decomposable similar to an area under the precision recall curve (AUCPR) and Recall@k. The machine learning model 220 learns to optimize for the validation metric and expects the validation metric to be a good indicator of the model performance M(f_{w}, Dₜₑₛₜ) on a test set Dₜₑₛₜ. In an example, the ML model 220 can be a neural network as shown in FIG. 3, but it appreciated that the ML model 220 can be any type of network (or not a neural network), including for example, a support vector machine (SVM).

In an example, the “evaluation metric” and “validation metric” refer to the same metric. The term “evaluation” refers to applying the metric on the test set, whereas “validation” refers to applying the metric on the validation set. In an example, the evaluation/validation metric does not change during training. Instead, the loss function (which is the differentiable function being optimized by stochastic gradient descent) changes in different training stages.

In an example, the term “ground truth” refers to a particular label used to assess whether a machine learning model makes a correct prediction or not. In a classification task, the ground truth can be the category that corresponds to the image, e.g., “dog” when shown a picture of a dog. In a metric learning task, the ground truth can be whether two images are of the “same” or “different” category (e.g., in a facial recognition application, it can be whether two images are of the same person or not).

In an example, the term “parametric model” refers to the learnable parameters or weights (e.g., the “weights” in a neural network that define the mapping from input to output). In an example, AUCPR and Recall@k are two evaluation metrics for indexing the performance of a machine learning system. AUCPR refers to the area under the precision-recall curve where a larger value means more area and therefore better performance. Recall@k can often be used to index how good an information retrieval system is. For example, when searching for a particular face identity in a data set of faces of different people, Recall@k may be calculated as (# of that person's face images @k retrieved image)/(total # of that person's face images).

Optimizing directly for evaluation metrics for the ML model 220, however, can be a challenging task. In an example, this is because model weights w are obtained by optimizing a loss function l on training set Dₜᵣₐᵢₙ, i.e., by solving min_{w} Σ_{(x,y)∈Dtrain}l(f_{w}(x), y). In some cases, however, the loss l is only a surrogate of the evaluation metric M, which can be non-differentiable with regard to the model weights w. Moreover, the loss l is optimized on the training set Dₜᵣₐᵢₙ instead of Dᵥₐₗ or Dₜₑₛₜ.

To address the above loss-metric mismatch issue (e.g., where a given loss function does not provide a good approximation with respect to an evaluation metric), the ML model 220 learns an adaptive loss function l_{Φ}(f_{w} (x), y) with loss parameters Φ∈R^{u}. In this example, the goal is to align the adaptive loss with the evaluation metric M on a held-out validation data Dᵥₐₗ. This leads to an alternate direction optimization problem: (1) finding metric-minimizing loss parameters Φ and (2) updating the model weights WO under the resultant loss l_{Φ} by, e.g., Stochastic Gradient Descent (SGD), which is illustrated in the following notation:

$$s . t . {w}_{Φ} = arg {min}_{w} \begin{matrix}{min}_{Φ} ℳ ( {f}_{w Φ} , {D}_{val} ) , \\ {\sum }_{( x , y ) ∈ {D}_{train}} {l}_{Φ} ( {f}_{w} ( x ) , y ) ,\end{matrix} \qquad ( 1 )$$

In an implementation, the outer loop and the inner loop are approximated by a few steps of iterative optimization (e.g., SGD updates). Hence, Φₜ is denoted as the loss function parameters at time step t and w_{Φt} as the corresponding model parameters. An aspect here is to bridge the gap between evaluation metric M and loss function l_{Φt} over time, conditioned on the found local optima w_{Φt}.

As discussed below, the ALA controller 230 performs a task where it proposes one or more updates to the aforementioned loss function that the main network (e.g., the ML model 220) is utilizing. The ALA controller 230 is enabled to see one or more past states in order to propose such updates of the loss function to the main network. After the main network trains using the updated loss function for a number of iterations, the ALA controller 230 can evaluate the main network using a validation data set to determine an improvement between prior to an update and after the update and/or between two respective updates.

As shown in FIG. 3, in an implementation, given the model state St at time t, the ALA controller 230 proposes an action aₜ=ΔΦₜ to update the loss function for follow-up training. The improvement in some evaluation metric (on validation set Dᵥₐₗ) is used as reward rt to update a policy network π_{θ} corresponding to the loss controller (e.g., the ALA controller 230). As explained further below, the policy network can refer to a neural network parameterized by a set of policy parameters. The ALA controller 230 is trained with one-step episodes (i.e., T=1) and is sample efficient. It is appreciated that a representation of the model state St and the type of information included therein depends on the type of task that the machine learning model is performing (e.g., classification, metric learning, etc.).

In an example, a developer of a machine learning model often cares about an evaluation metric such as a classification error of a model being trained. Since a classification error is a numeric value, and a lower value of the classification error is considered better, an improvement in this metric is measured by its decrease during training. Similarly, when using AUCPR, where a higher value is considered better, an improvement in this metric is measured by its increase during training.

To capture the conditional relations between loss and evaluation metric, a reinforcement learning problem is formulated. In an example, to address such a problem, the task is to predict the best change ΔΦₜ to loss parameters Φₜ such that optimizing the adjusted loss aligns better with the evaluation metric M(f_{wΦt}, Dᵥₐₗ). Stated another way, taking an action that adjusts the loss function should produce a reward that reflects how much the metric M will improve on validation data Dᵥₐₗ. This is analogous to teaching the ML model 220 how to better optimize on seen training data Dₜᵣₐᵢₙ and to better generalize (in terms of M) on unseen validation data Dᵥₐₗ.

In an example, the underlying model behind reinforcement learning (RL) is a Markov Decision Process (MDP) defined by states s ∈S and actions a ∈A at discrete time steps t within an episode. In the example shown in FIG. 3, an episode is defined as a set of T consecutive time steps, each consisting of K training iterations. The RL policy collects episodes at a slower timescale than the training of the model f_{w}.

FIG. 3 illustrates the schematic of a RL framework. The state sₜ records training progress information (e.g., w_{Φt}-induced loss value), and the loss-updating action aₜ=ΔΦₜ is sampled from a stochastic policy η_{θ}(aₜ|sₜ). In an example, the policy (or “policy network”) is implemented as a neural network parameterized by policy parameters θ. Training f_{w} under the updated loss l_{Φt+1} will transition to a new state sₜ₊₁ and produce a reward signal rₜ=r(sₜ, aₜ). The reward by the improvement is defined in an evaluation metric M(f_{wΦt}, Dᵥₐₗ).

The loss-controlling policy is optimized with a policy gradient approach where the objective is to maximize the expected total return as defined by the following notation:

J(θ)= [symbol] _{τ}[R(τ)], (2)

where R(τ) is the total return R(τ)=Σₜ₌₀^{T}rₜ of an episode τ={sₜ, aₜ|t∈[0, T]}.

The updates to the policy parameters θ are given by the gradient denoted by the following:

$${∇}_{θ} J ( θ ) = {𝔼}_{r} [ {\sum }_{t = 0}^{T} {∇}_{θ} log {π}_{θ} ( {a}_{t} \vert st ) {\sum }_{k = t}^{T} ( {r}_{k} - {b}_{k} ) ] , \qquad ( 3 )$$

where bₖ is a variance-reducing baseline reward implemented as the exponential moving average of previous rewards.

The following discusses locally policy learning. As shown in FIG. 3, an episode for RL is a set of T consecutive time steps. In an example, when one extreme is chosen, T could cover the entire length of a training run of f_{w}. However, waiting for the ML model 220 to fully train and repeating this process enough times for a policy to converge can require a significant amount of computational resources. In an example, the other extreme is chosen as a starting point where episodes of a single step, i.e., T=1 (still composed of K training iterations) are utilized. An advantage of this approach is that a single training run of f_{w} can contribute many episodes to the training of the policy network π₀, making it sample efficient.

Although the example of FIG. 3 discusses one type of loss function, it is appreciated that the subject technology is enabled to use other types of loss functions, as long as such loss functions can be parameterized and a state can be measured, then the same ALA technique described herein can be utilized.

The following discussion describes the concrete RL algorithm for simultaneous learning of the ALA policy parameters θ and model weights w.

The reward function rₜ measures the relative reduction in validation metric M(f_{wΦt}, Dᵥₐₗ), after K number of iterations of performing gradient descent with an updated loss function l_{Φt+1}. The following notation represents the cumulative performance between model updates:

$${ℳ}_{i + 1} = {\sum }_{j = 1}^{K} {γ}^{K - j} ℳ ( {f}_{wi} , {D}_{val} ) , \qquad ( 4 )$$

where γ is a discount factor that weighs more on the recent metric.

The main model weights TO are updated for K iterations. The reward rₜ to ±1 is then quantized by sign(Mₜ−Mₜ₊₁), which advantageously encourages consistent error metric decreases regardless of magnitude. Further, the terminal reward is defined in case of arriving at the maximum training iteration. In this case, Mₜ is compared with a pre-defined threshold ϑ∈R, which can be set as the converged evaluation metric from regular training without a loss controller (e.g., the ALA controller 230), which may be represented by the following notation:

$${r}_{t} = \{ \begin{matrix}sign ( {ℳ}_{t} - {ℳ}_{t + 1} ) , & for non \text{-} terminal {s}_{t} \\ sign ( \text{?} - {ℳ}_{t} ) , & for terminal {s}_{t} .\end{matrix} \\ \text{?} \text{indicates text missing or illegible when filed} \qquad ( 5 )$$

For every element Φₜ(i) of the loss parameters Φₜ, action aₜ(i) is sampled from the discretized space A={−β, 0, β}, with β being a predefined step-size. Actions are used to update the loss parameters Φₜ(i)=Φₜ₋₁(i)+aₜ(i) at each time step. The ALA policy network no has |A| output neurons for each loss parameter, and aₜ is sampled from a softmax distribution over these neurons.

In an implementation, the policy network state sₜ∈S includes four components:
1. Some task dependent validation statistics S(f_{wΦ}_{ᵢ}, Dᵥₐₗ), e.g., the log probabilities of different classes, observed au multiple timesteps {t, t−1, . . . }.
2. The relatice change ΔS(f_{wΦ}_{ᵢ}, Dᵥₐₗ) of validation statistics from their moving average.
3. The current loss parameters Φᵢ
4. The current iteration number normalized by t total iterations of the full training run of f_{w}.

For the policy network state, validation statistics are utilized, among others, to capture model training states. One objective is to find rewarding loss-updating actions aₜ=ΔΦₜ to improve the evaluation metric on a validation set. A successful loss control policy can be able to model the implicit relation between the validation statistics, which is the state of the RL problem, and the validation metric, which is the reward. Stated another way, the ALA technique learns to mimic the loss optimization process for decreasing the validation metric cumulatively. Validation statistics are chosen instead of training statistics in the policy network state sₜ because the former is a natural proxy of the validation metric. In an example, the validation statistics are normalized in the state representation. This allows for generic policy learning which is independent of the actual model predictions from different tasks or loss formulations.

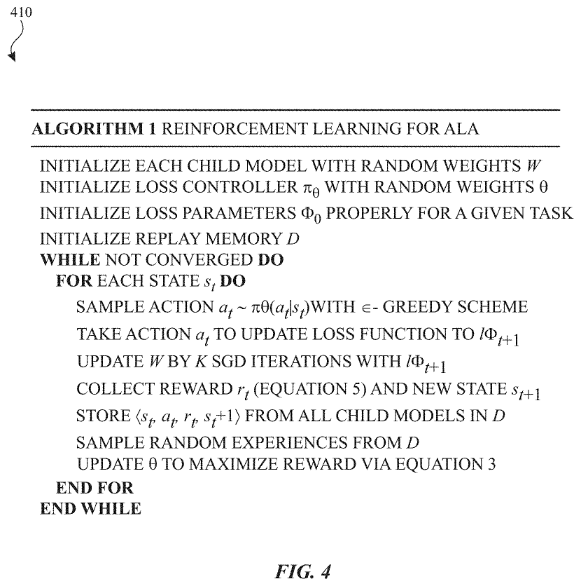

FIG. 4 conceptually illustrates example statements for an algorithm that implements reinforcement learning for adaptive loss alignment (ALA) in accordance with one or more implementations. In an example, the algorithm illustrated in FIG. 4 may be executed by the ALA controller 230 on the electronic device 110 (or the server 120).

As shown in FIG. 4, an algorithm 410 includes statements illustrating an example implementation of a RL algorithm that alternates between updating a loss control policy network no and updating model weights w. A policy learning can be enhanced by training in parallel multiple main networks, which can be referred to as child models. Each child model is initialized with random weights w and sharing a loss controller (e.g., the ALA controller 230) corresponding to a policy network no. At each time step t for policy update, the episodes are collected using the policy network no from all the child models. This independent set of episodes, together with replay memory D that adds randomness to the learning trajectories, help to alleviate the non-stationariness in online policy learning. As a result, more robust policies are learned.

It is worth noting that the initial loss parameters (Do can be important for efficient policy learning. In an example, proper initialization of (Do must ensure default loss function properties that depend on the particular form of loss parameterization for a given task, e.g., identity class correlation matrix in classification. Stochastic action sampling from no and a standard E-greedy strategy can be utilized to encourage exploration in learning.

The following discussion relates to instantiation in example learning problems, including classification and metric learning.

With respect to classification, the subject technology learns to adapt the following parametric classification loss function:

l_{Φ}_{ᵢ}(f_{w}(x),y)=−σ(y^{T}Φₜ log f_{w}(y|x)), (6)

where σ(⋅) is the sigmoid function, and Φᵢ ∈ [symbol] ^{|y|×|y|} denotes the loss function parameters with |y| being the number of classes. y ∈{0, 1}^{|y|} denotes the one-hot representation of class labels, and f_{w}(y/x)∈ [symbol] ^{|y|} denotes the output multinomial distribution of the model,

The matrix Φₜ encodes time-varying class correlations. A positive value of Φₜ(i, j) encourages the model to increase the prediction probability of class/given ground-truth class i. A negative value of Φₜ(i, j), on the other hand, penalizes the confusion between class i and j. Thus, when Φₜ changes as learning progresses, it is possible to implement a hierarchical curriculum for classification, where similar classes are grouped as a super class earlier in training, and discriminated later as training goes further along. To learn the curriculum automatically, Φ₀ is initialized as an identity matrix (e.g., reduced to the standard cross-entropy loss in this case), and update Φₜ over time by the ALA policy η_{θ}.

To learn to update (IN, a confusion matrix C(f_{wΦt}, Dᵥₐₗ) ∈R^{|Y|×|Y|} of model prediction on validation set Dᵥₐₗ is constructed, which can be represented by the following example notation:

$${C}_{i , j} = \frac{{\sum }_{d = 1}^{\vert {D}_{val} \vert} - I ( {y}_{d} , i ) log {f}_{w {Φ}_{t}}^{j} ( {x}_{d} )}{{\sum }_{d = 1}^{\vert {D}_{val} \vert} I ( {y}_{d} , i )} , \qquad ( 7 )$$

whew I(y_{d},i) is an indicator function outputting 1 when y_{d} equals class i and 0 otherwise,

In an example, a parameter efficient approach is implemented to update each loss parameter Φₜ(i, j) based on the observed class confusions [C_{i,j}, C_{j,i}]. In other words, the ALA controller 230 collects the validation statistics S(f_{wΦt}, Dᵥₐₗ) only for class pairs at each time step t, in order to construct state sₜ for updating the corresponding loss parameter Φₜ(i, j). Different class pairs share the same loss controller (e.g., the ALA controller 230), and the loss parameters Φₜ(i,j) and Φₜ(i, j) are updated to the same value (normalized between [−1, 1]) to ensure class symmetry. This implementation is more parameter efficient than learning to update the whole matrix Φₜ based on the matrix C. Furthermore, it does not depend on the number of classes for a given task, thus enabling transferring the learned policy to another classification task with an arbitrary number of classes.

With respect to a metric learning problem for machine learning, the metric learning problem learns a distance metric to encode semantic similarity. A distance metric refers to a measure of semantic similarity. In an example, the resulting distance metric cannot directly cater to different, and sometimes contradicting performance metrics of interest (e.g., verification vs. identification rate, or precision vs. recall). This gap is more pronounced in the presence of common techniques such as hard mining that only have indirect effects on final performance. Therefore, metric learning can serve as a strong testbed for learning methods that directly optimize evaluation metrics. A standard triplet loss for metric learning can be formulated as the following notation:

lₜᵣᵢ(f_{w}(x_{i,i+,i-}))=max(0,F(d⁺)−F(d⁻)+η), (8)

where F(d)=d² is the squared distance function over both d⁺ (distance between anchor instance f_{w} (xᵢ) and positive instance f_{w}(xₜ+)) and d⁻ (distance between f_{w}(xᵢ) and negative instance f_{w}(xᵢ−)), while η is margin parameter.

In an example, the shape of the distance function matters. The concave shape of −d² for negative distance d⁻ will lead to diminishing gradients when d⁻ approaches zero. In this instance, the distance function is reshaped adaptively with two types of loss parameterizations.

For the first parametric loss, called distance mixture, five (5) different-shaped distance functions are adopted for both d⁺ and d⁻, and learn a linear combination of them via Φₜ which can be represented by the following:

$${l}_{{Φ}_{t}} = {\sum }_{i = 1}^{5} {Φ}_{t} ( i ) {F}_{i}^{+} ( {d}^{+} ) + {\sum }_{j = 1}^{5} {Φ}_{t} ( j ) {F}_{j}^{-} ( {d}^{-} ) , \qquad ( 9 )$$

when Fᵢ⁺ and F₃⁻ (⋅) correspond to the increasing and decreasing distance functions to penalize large d⁺ and small d⁻ respectively.

In this case Φₜ=[{Φₜ(i)}, {Φₜ(j)}]∈[0, 1]¹⁰, and is initialized as a binary vector such that Φ₀ selects the default distance functions d² and 0.5 d⁻¹ for d⁺ and d⁻. For RL, the validation statistics in state sₜ are simply represented by the computed distance Fᵢ⁺(⋅) or Fⱼ⁻(⋅), and the ALA controller 230 updates Φₜ(i) or Φₜ(j) accordingly. In an example, performance is not sensitive to the design choices of Fᵢ⁺(⋅) and Fⱼ⁻(⋅). Rather, it can be more important to learn the dynamic weightings of Fᵢ⁺(⋅) and Fⱼ⁻(⋅).

A Focal weighting-based loss formulation can be represented by the following:

$${l}_{{Φ}_{t}} = \frac{1}{{Φ}_{t} ( 1 )} log [ 1 + {\sum }_{i +} exp ( {Φ}_{t} ( 1 ) \cdot ( {d}_{{i}^{+}}^{+} - α ) ) ] + \frac{1}{{Φ}_{t} ( 2 )} log [ 1 + {\sum }_{i -} exp ( - {Φ}_{i} ( 2 ) \cdot ( {d}_{{i}^{-}}^{-} - α ) ) ] , \qquad ( 10 )$$

where Φₜ∈ [symbol] ², and dᵢ₊⁺ and dᵢ₋⁻ denote the distance between anchor instance and the positive i⁺ and negative i⁻ instances in the batch.

In the above example, these distances are utilized as validation statistics for ALA controller to update Φₜ while α is the distance offset.

In an implementation, the main model architecture as illustrated in FIG. 3 and a maximum number of training iterations are task-dependent. In a parallel training scenario, 10 child models can be trained sharing the same ALA controller (e.g., the ALA controller 230). The ALA controller 230, for example, is instantiated as a multilayer perceptron consisting of 2 hidden layers each with 32 ReLU units. A state sₜ includes a sequence of validation statistics observed from past 10 time steps.

In an example, the ALA controller 230 is learned using a REINFORCE policy gradient method with a learning rate of 0.001. Experience is collected from all child networks every K=200 SGD time steps. In the E-greedy strategy, linear annealing of ϵ is performed from 1 to 0.1 during policy learning. The following are set: discount factor y=0.9, loss update quantity β=0.1 and distance offset α=1. Performance is robust to variations of these hyper-parameters.

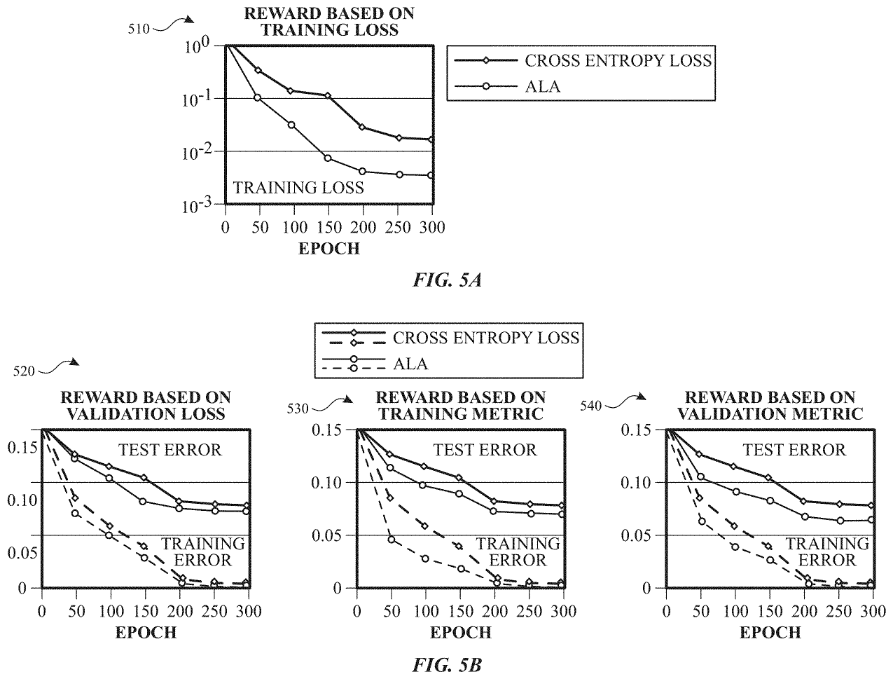

FIG. 5 conceptually illustrates example charts with an analysis of optimization vs. generalization in accordance with one or more implementations. The charts in FIG. 5 show an analysis of the effects of ALA policies on optimization and generalization behavior by switching the reward signal in a 2-factor design: training vs. validation data and loss vs. evaluation metric on a CIFAR-10 data set with 50 k images for training and 10 k image for testing. When the training loss (i.e., the default cross-entropy loss) or metric is used as reward, these values are computed using the whole training set Drain.

FIG. 5 includes chart 510 illustrating a comparison of optimization performance in terms of the raw cross-entropy loss outputs on training data. As shown, the ALA is rewarded by the training loss, and the measured training loss is consistently lower compared to the fixed cross-entropy loss, indicating improved optimization. More specifically, chart 510 isolates the optimization effects by comparing ALA, with the cross-entropy loss as the reward, and minimizing cross-entropy loss directly. As illustrated, ALA is shown with consistently lower loss values even as chart 510 shows that ALA is facilitating optimization even when the objective is fully differentiable.

FIG. 5 includes chart 520, chart 530, and chart 540 comparing ALA policies trained with different rewards: the validation loss-based reward improves both optimization (training error) and generalization (test error), and the gains are larger when using the validation metric-based reward. In contrast, using the training metric as the reward yields smaller gains in test error, potentially due to the diminishing reward (error approaching zero) in training data.

As shown, chart 520, chart 530, and chart 540 provide an examination of both optimization and generalization when ALA uses validation loss as a reward where training and test (generalization) errors for ALA and fixed cross-entropy loss are monitored. In these charts, the generalization error on a test set is improved, and the optimization in training error also provides small improvements. The optimization and generalization gains are larger when the validation metric is used as a reward, which further addresses the loss-metric mismatch. By comparison, the training metric-based reward yields faster training error decrease, but smaller gains in test error are seen potentially due to the diminishing error/reward in the training data.

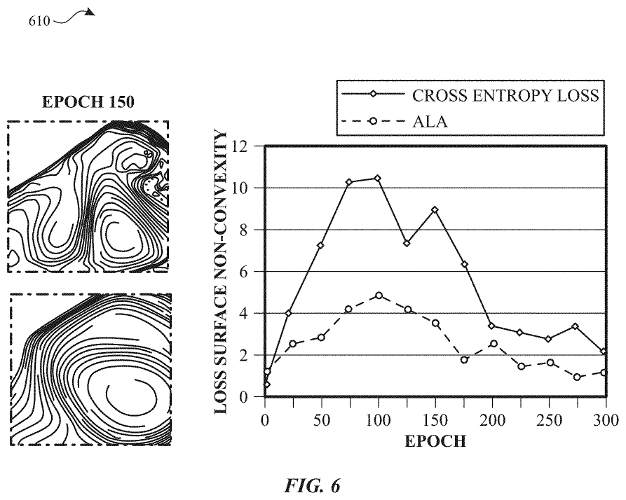

FIG. 6 conceptually illustrates an example chart with an analysis loss surface non-convexity in accordance with one or more implementations. FIG. 6 includes a chart 610 that illustrates an analysis of the loss surface non-convexity on a CIFAR-10 data set. For both the fixed cross entropy loss and ALA, a loss surface along filter-normalized 2D directions are computed at different training epochs. In this example, non-convexity is measured as the average Gaussian curvature for each point in the 2D loss surface.

ALA improves optimization by dynamically smoothing the loss landscape. To verify, measurements of the loss surface convexity are taken, and the Gaussian curvature of the loss surface around each model checkpoint following are calculated. In FIG. 6, chart 610 shows a smoother loss surface from the model trained with ALA. This confirms that ALA is learning to manipulate the loss surface in a way that improves convergence of SGD based optimization processes.

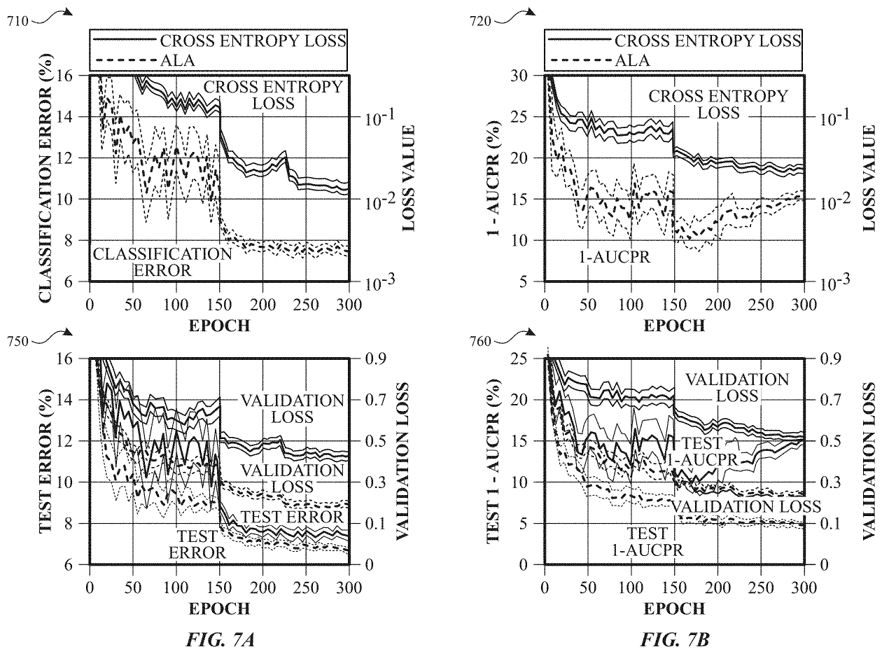

FIG. 7 conceptually illustrates example charts with an analysis of loss-metric mismatch, and validation loss vs. test metric of classification error, and area under the precision-recall curve (AUCPR) in accordance with one or more implementations.

As discussed before, default loss functions may not provide good approximations to evaluation metrics, which is referred to as a loss-metric mismatch. This is illustrated in chart 710 and 720. In chart 710, a loss-metric mismatch on a CIFAR-10 data set is shown comparing cross-entropy loss on the training set vs. classification error on the test set. In chart 720, a comparison is shown corresponding to a cross-entropy loss on the training set vs. area under the precision recall curve (AUCPR) on the test set. In these examples, all curves are averaged over 10 runs initialized with different random seeds, with shaded areas showing the standard deviations. Training loss and evaluation metric curves differ in shape and noise characteristics in chart 710 and 720.

As further illustrated in FIG. 7, chart 750 shows a comparison of a validation loss vs. test metric of a classification error and chart 760 shows AUCPR on a CIFAR-10 data set. In these examples, curves are means over 10 runs initialized with different random seeds, and shaded areas show standard deviations. ALA uses the default reward based on the validation error metric, and improves both validation loss and test metric by addressing the loss-metric mismatch (both before and after the loss/metric drop due to learning rate change).

ALA improves performance by addressing the loss-metric mismatch in chart 750 and 760. In FIG. 7, chart 710 shows CIFAR-10 training with ALA using classification error and chart 760 shows CIFAR-10 training with ALA using AUCPR metrics. In these examples, a validation metric-based reward for ALA is utilized by default, and follows the aforementioned training settings for each metric. As shown, the fixed cross-entropy loss, without explicit loss-metric alignment, suffers from an undesirable mismatch between the monitored validation loss and test metric in both cases (see the different curve shapes and variances). ALA reduces the loss-metric mismatch by sequentially aligning the loss to the evaluation metric, even though classification error and AUCPR cases exhibit different patterns. In doing so, ALA not only lowers the validation loss but also the generalization test error.

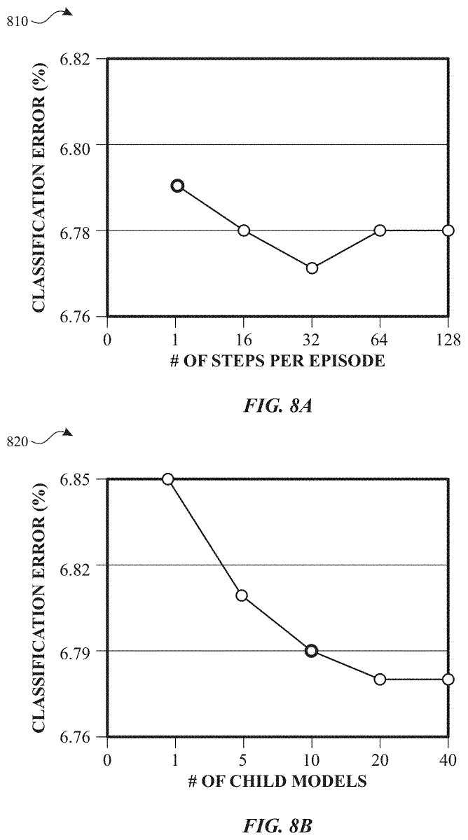

FIG. 8 conceptually illustrates example charts illustrating sample efficiency of a RL approach for ALA in accordance with one or more implementations. More specifically, the charts in FIG. 8 show the sample efficiency of the RL approach for ALA with a validation metric as reward. In these examples, a classification error of a ResNet-32 image classification network is reported on a CIFAR-10 data set, and good performance can be achieved using the default RL settings with one-step episodes and 10 child model training that are sample efficient.

FIG. 8, in particular, illustrates the sample efficiency of ALA's RL approach in the example task of CIFAR-10 classification. The ResNet-32 model is trained and the default reward that is based on the validation metric is utilized. In FIG. 8, chart 810 shows that using episodes including a single training step suffices to learn competent loss policies with good performance. Further, in FIG. 8, chart 820 shows improvements from parallel training with multiple child models that provide more episodes for policy learning. In these examples, 10 child models are utilized, which only incurs an extra 30% time cost for policy learning, thus striking good trade off performance.

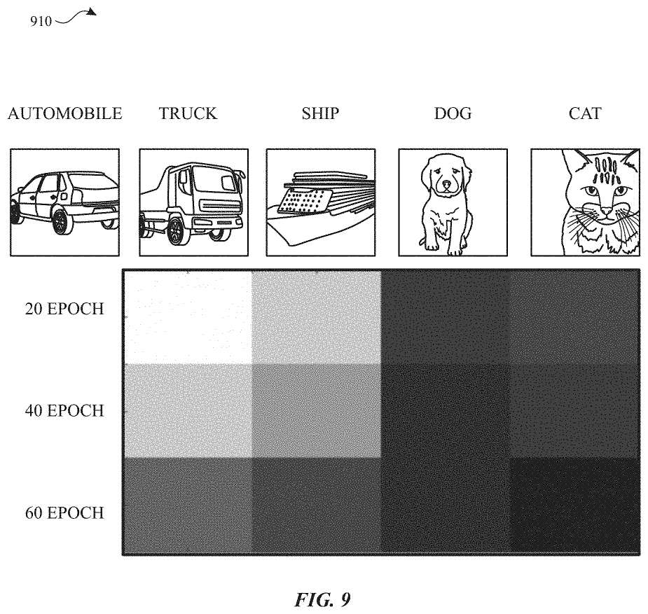

FIG. 9 conceptually illustrates an example chart illustrating an evolution of class correlation scores on a given image data set in accordance with one or more implementations. As shown in FIG. 9, a chart 910 illustrates an evolution of class correlation scores Φₜ(i, j) on a CIFAR-10 data set (with ResNet-32 network). In chart 910, a light or dark portion denotes positive or negative values, respectively. In this example, the policy modifies the class correlation scores in a way that forms a hierarchical classification curriculum by merging similar classes and gradually separating them.

FIG. 9, in particular, illustrates the ALA policy learned for classification, which performs actions to adjust the loss parameters in Φₜ (i.e., class correlations) dynamically. For example, it can be observed that the ALA controller 230 tends to first merge similar classes with positive Φₜ (i, j), and then gradually discriminates between them with negative Φₜ(i, j). This indicates a learned curriculum that guides model learning to achieve both better optimization and generalization.

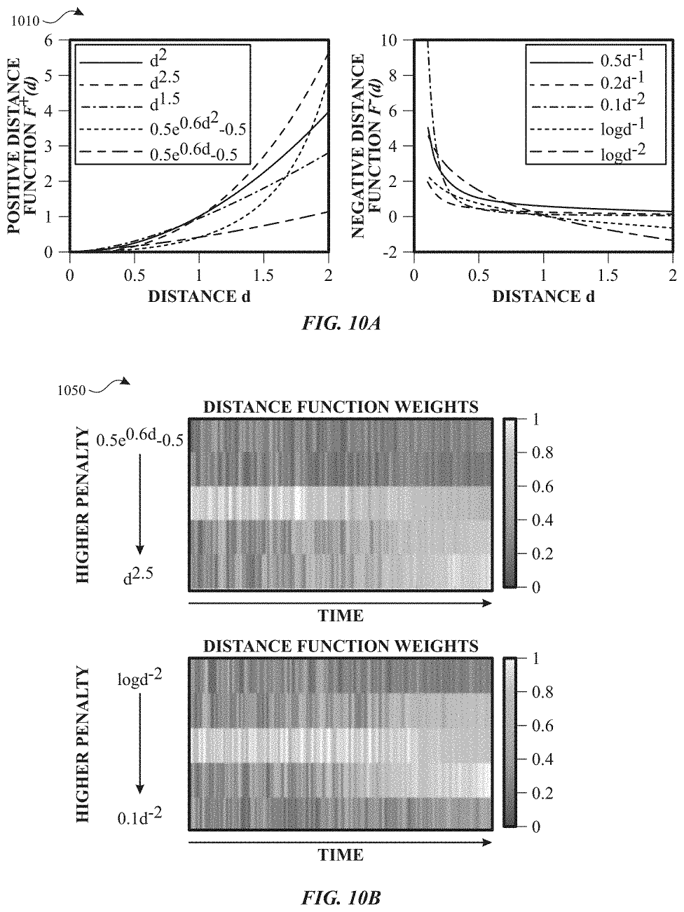

FIG. 10 conceptually illustrates example charts illustrating a positive distance function and a negative distance function in metric learning in accordance with one or more implementations.

In the example charts of FIG. 10, a visualization of a learned ALA policy for metric learning under a parametric loss formulation that mixes different distance functions is provided. In FIG. 10, chart 1010 first shows the distance functions Fᵢ⁺(⋅) or Fᵢ⁻(⋅) and apply to distance d⁺ (between anchor and positive instances) and distance d⁺ (between anchor and negative instances), respectively. In these examples, performance is relatively robust to the design choices of distance functions, as long as such functions differ, while the ability to learn their adaptive weightings plays a more important role.

In FIG. 10, chart 1050 demonstrates the evolution of weights Φₜ(i) over the distance functions on a given products data set. While the weights for the default distance functions d² and 0.5 d⁻¹ are both initialized as 1, the ALA controller 230 learns to assign larger weights to those high-penalty distance functions over time. This implies an adaptive “hard mining” curriculum learned from data that is more flexible than hand-designed alternatives.

It is appreciated that the ALA techniques described herein can be applied to other applications. In an example, ALA can be applied to multiple simultaneous objectives, where the ALA controller 230 weighs between these objectives dynamically. In another example, the ALA techniques can be applied to cases where the output of a given model is an input into a more complex pipeline, which may be common in production systems (e.g., detection—alignment—recognition pipelines). In these systems, further machinery can be developed for making reward evaluation efficient enough to learn the policy jointly with training the different modules.

Another area where ALA can be applied is to make ALA less dependent on specific task types and loss/metric formulations. In an example, the ALA controller 230 can be trained through continual learning and/or crowd learning to handle different scenarios flexibly. This enables the use of ALA in distributed crowd learning settings where model training gets better and better over time.

Further, ALA may be applied in dynamically changing environments where available training data can change over time (e.g., life-long learning, online learning, meta-learning).

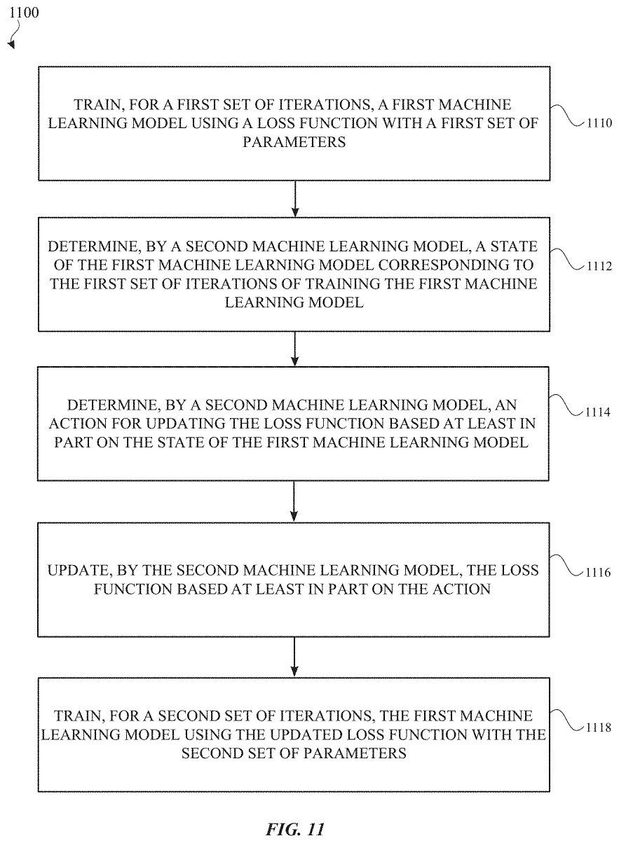

FIG. 11 illustrates a flow diagram of an example process 1100 for providing an adaptive loss alignment for training a machine learning model in accordance with one or more implementations. For explanatory purposes, the process 1100 is primarily described herein with reference to components of the computing architecture of FIG. 2, which may be executed by one or more processors of the electronic device 110 of FIG. 1. However, the process 1100 is not limited to the electronic device 110, and one or more blocks (or operations) of the process 1100 may be performed by one or more other components of other suitable devices, such as by the server 120. Further for explanatory purposes, the blocks of the process 1100 are described herein as occurring in serial, or linearly. However, multiple blocks of the process 1100 may occur in parallel. In addition, the blocks of the process 1100 need not be performed in the order shown and/or one or more blocks of the process 1100 need not be performed and/or can be replaced by other operations.

The process 1100 describes different sets of iterations that are a subset of a total number of iterations for a full training run of a given machine learning model. The electronic device 110 trains, for a first set of iterations, a first machine learning model using a loss function with a first set of parameters (1110). In an example, the first set of iterations can refer to an initial episode, at a first time step, that includes K number of training iterations, and the first machine learning model refers to the main model or “child model” as discussed before. The electronic device 110 determines, by a second machine learning model, a state of the first machine learning model corresponding to the first set of iterations of training the first machine learning model (1112). In an example, the second machine learning model refers to the loss controller (e.g., ALA controller 230) which is implemented as a neural network (e.g., the policy network) as discussed before. The electronic device 110 determines, by the second machine learning model, an action for updating the loss function based at least in part on the state of the first machine learning model, where the action corresponds to a change in values of the first set of parameters (1114). In an example, the action refers action aₜ(i) as discussed before. The electronic device 110 updates, by the second machine learning model, the loss function based at least in part on the action, where the updated loss function includes a second set of parameters corresponding to the change in values of the first set of parameters (1116). In an example, the updated loss function refers to updated loss function l_{Φt+1} as discussed before. The electronic device 110 trains, for a second set of iterations, the first machine learning model using the updated loss function with the second set of parameters, where the first set of iterations and the second set of iterations are a subset of a total number of iterations for a full training run of the first machine learning model (1118). In an example, the second set of iterations refers to a subsequent episode, at a second time step, that includes another K number of training iterations, and the full training run includes a T number of episodes.

FIG. 12 illustrates an electronic system 1200 with which one or more implementations of the subject technology may be implemented. The electronic system 1200 can be, and/or can be a part of, the electronic device 110, and/or the server 120 shown in FIG. 1. The electronic system 1200 may include various types of computer readable media and interfaces for various other types of computer readable media. The electronic system 1200 includes a bus 1208, one or more processing unit(s) 1212, a system memory 1204 (and/or buffer), a ROM 1210, a permanent storage device 1202, an input device interface 1214, an output device interface 1206, and one or more network interfaces 1216, or subsets and variations thereof.

The bus 1208 collectively represents all system, peripheral, and chipset buses that communicatively connect the numerous internal devices of the electronic system 1200. In one or more implementations, the bus 1208 communicatively connects the one or more processing unit(s) 1212 with the ROM 1210, the system memory 1204, and the permanent storage device 1202. From these various memory units, the one or more processing unit(s) 1212 retrieves instructions to execute and data to process in order to execute the processes of the subject disclosure. The one or more processing unit(s) 1212 can be a single processor or a multi-core processor in different implementations.

The ROM 1210 stores static data and instructions that are needed by the one or more processing unit(s) 1212 and other modules of the electronic system 1200. The permanent storage device 1202, on the other hand, may be a read-and-write memory device. The permanent storage device 1202 may be a non-volatile memory unit that stores instructions and data even when the electronic system 1200 is off. In one or more implementations, a mass-storage device (such as a magnetic or optical disk and its corresponding disk drive) may be used as the permanent storage device 1202.

In one or more implementations, a removable storage device (such as a floppy disk, flash drive, and its corresponding disk drive) may be used as the permanent storage device 1202. Like the permanent storage device 1202, the system memory 1204 may be a read-and-write memory device. However, unlike the permanent storage device 1202, the system memory 1204 may be a volatile read-and-write memory, such as random access memory. The system memory 1204 may store any of the instructions and data that one or more processing unit(s) 1212 may need at runtime. In one or more implementations, the processes of the subject disclosure are stored in the system memory 1204, the permanent storage device 1202, and/or the ROM 1210. From these various memory units, the one or more processing unit(s) 1212 retrieves instructions to execute and data to process in order to execute the processes of one or more implementations.

The bus 1208 also connects to the input and output device interfaces 1214 and 1206. The input device interface 1214 enables a user to communicate information and select commands to the electronic system 1200. Input devices that may be used with the input device interface 1214 may include, for example, alphanumeric keyboards and pointing devices (also called “cursor control devices”). The output device interface 1206 may enable, for example, the display of images generated by electronic system 1200. Output devices that may be used with the output device interface 1206 may include, for example, printers and display devices, such as a liquid crystal display (LCD), a light emitting diode (LED) display, an organic light emitting diode (OLED) display, a flexible display, a flat panel display, a solid state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 12, the bus 1208 also couples the electronic system 1200 to one or more networks and/or to one or more network nodes, such as the electronic device 110 shown in FIG. 1, through the one or more network interface(s) 1216. In this manner, the electronic system 1200 can be a part of a network of computers (such as a LAN, a wide area network (“WAN”), or an Intranet, or a network of networks, such as the Internet. Any or all components of the electronic system 1200 can be used in conjunction with the subject disclosure.

Implementations within the scope of the present disclosure can be partially or entirely realized using a tangible computer-readable storage medium (or multiple tangible computer-readable storage media of one or more types) encoding one or more instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

As used in this specification and any claims of this application, the terms “base station”, “receiver”, “computer”, “server”, “processor”, and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
training, for a first set of iterations, a first machine learning model using a loss function with a first set of parameters;
determining, by a second machine learning model, a state of the first machine learning model corresponding to the first set of iterations of training the first machine learning model;
determining, by the second machine learning model, an action for updating the loss function based at least in part on the state of the first machine learning model, wherein the action corresponds to a change in values of the first set of parameters;
updating, by the second machine learning model, the loss function based at least in part on the action, wherein the updated loss function includes a second set of parameters corresponding to the change in values of the first set of parameters; and
training, for a second set of iterations, the first machine learning model using the updated loss function with the second set of parameters, wherein the first set of iterations and the second set of iterations are a subset of a total number of iterations for a full training run of the first machine learning model.

2. The method of claim 1, wherein the first machine learning model comprises a first neural network and the second machine learning model comprises a second neural network that differs from the first neural network.

3. The method of claim 1, wherein the first set of iterations and the second set of iterations correspond to a respective time step, the respective time step including a K number of training iterations for training the first machine learning model, and the full training run of the first machine learning model corresponds to a number of episodes, each episode comprising a T number of time steps.

4. The method of claim 1, wherein the second machine learning model comprises a loss controller that is trained through continual learning or crowd learning.

5. The method of claim 1, wherein the action comprises updating a set of parameters provided by outputs of the second machine learning model.

6. The method of claim 1, wherein the state of the first machine learning model comprises information corresponding to: a progression of the training of the first machine learning model, the information including current parameters of the loss function, a set of validation statistics, a relative change of the set of validation statistics from a moving average of validation statistics, and a current iteration number normalized by the total number of iterations for training the first machine learning model.

7. The method of claim 1, further comprising:
determining a reward signal for the second machine learning model after performing the second set of iterations for training the first machine learning model, wherein the reward signal is based at least in part on an improvement in an evaluation metric of the first machine learning model; and
updating, using the reward signal, a set of parameters of the second machine learning model.

8. The method of claim 7, wherein the evaluation metric is determined based at least in part on a validation data set utilized for evaluation of the first machine learning model and the reward signal is based on a relative reduction in the evaluation metric after a K number of iterations performing a gradient descent operation with an updated loss function.

9. The method of claim 7, further comprising:
determining, by the second machine learning model, a second state of the first machine learning model corresponding to the second set of iterations of training the first machine learning model.

10. The method of claim 9, further comprising:
determining, by the second machine learning model, a second action for updating the loss function, that was updated previously using the action, based at least in part on the second state of the first machine learning model, wherein the second action corresponds to a change in values of the second set of parameters; and
updating, by the second machine learning model, the loss function based at least in part on the second action, wherein the loss function includes a third set of parameters corresponding to the change in values of the second set of parameters.

11. A system comprising:
a processor;
a memory device containing instructions, which when executed by the processor cause the processor to:
train, for a first set of iterations, a first machine learning model using a loss function with a first set of parameters;
determine, by a second machine learning model, a state of the first machine learning model corresponding to the first set of iterations of training the first machine learning model;
determine, by the second machine learning model, an action for updating the loss function based at least in part on the state of the first machine learning model, wherein the action corresponds to a change in values of the first set of parameters;
update, by the second machine learning model, the loss function based at least in part on the action, wherein the updated loss function includes a second set of parameters corresponding to the change in values of the first set of parameters; and
train, for a second set of iterations, the first machine learning model using the updated loss function with the second set of parameters, wherein the first set of iterations and the second set of iterations are a subset of a total number of iterations for a full training run of the first machine learning model.

12. The system of claim 11, wherein the first machine learning model comprises a first neural network and the second machine learning model comprises a second neural network that differs from the first neural network.

13. The system of claim 11, wherein the first set of iterations and the second set of iterations correspond to a respective time step, the respective time step including a K number of training iterations for training the first machine learning model, and the full training run of the first machine learning model corresponds to a number of episodes, each episode comprising a T number of time steps.

14. The system of claim 11, wherein the second machine learning model comprises a loss controller that is trained through continual learning or crowd learning.

15. The system of claim 11, wherein the action comprises updating a set of parameters provided by outputs of the second machine learning model.

16. The system of claim 11, wherein the state of the first machine learning model comprises information corresponding to: a progression of the training of the first machine learning model, the information including current parameters of the loss function, a set of validation statistics, a relative change of the set of validation statistics from a moving average of validation statistics, and a current iteration number normalized by the total number of iterations for training the first machine learning model.

17. The system of claim 11, wherein the memory device contains further instructions, which when executed by the processor further cause the processor to:
determine a reward signal for the second machine learning model after performing the second set of iterations for training the first machine learning model, wherein the reward signal is based at least in part on an improvement in an evaluation metric of the first machine learning model; and
update, using the reward signal, a set of parameters of the second machine learning model.

18. The system of claim 17, wherein the evaluation metric is determined based at least in part on a validation data set utilized for evaluation of the first machine learning model and the reward signal is based on a relative reduction in the evaluation metric after a K number of iterations performing a gradient descent operation with an updated loss function.

19. The system of claim 17, wherein the memory device contains further instructions, which when executed by the processor further cause the processor to:
determine, by the second machine learning model, a second state of the first machine learning model corresponding to the second set of iterations of training the first machine learning model.

20. A non-transitory computer-readable medium comprising instructions, which when executed by a computing device, cause the computing device to perform operations comprising:
training, for a first set of iterations, a first machine learning model using a loss function with a first set of parameters;
determining, by a second machine learning model, a state of the first machine learning model corresponding to the first set of iterations of training the first machine learning model;
determining, by the second machine learning model, an action for updating the loss function based at least in part on the state of the first machine learning model, wherein the action corresponds to a change in values of the first set of parameters;
updating, by the second machine learning model, the loss function based at least in part on the action, wherein the updated loss function includes a second set of parameters corresponding to the change in values of the first set of parameters; and
training, for a second set of iterations, the first machine learning model using the updated loss function with the second set of parameters, wherein the first set of iterations and the second set of iterations are a subset of a total number of iterations for a full training run of the first machine learning model.
